(19) United States
(12) Patent Application Publication
(10) Pub. No.: US 2003/0126049 A1
(43) Pub. Date: Jul. 3, 2003

(54) Programmed assessment of technological, legal and management risks

(76) Inventors: Douglas A. Nagan, Deep River, CT (US); Edward M. Dunham JR., Philadelphia, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/035,890

(22) Filed: Dec. 31, 2001

(51) Int. Cl. G06F 17/60

(52) U.S. Cl. 705/35

(57) ABSTRACT

Potential risk exposures of an organization's activities in new and evolving areas where historical data is not available, are assessed using a programmed technique and expert algorithm. A questionnaire prompts for answers that must be selected from a limited quantifiable set, or alternatively will default to a high risk assessment. The answers are scored using an algorithm that computes potential risk levels using stored data and expert rules. A report is generated containing information identifying potential risk levels and preferably contains recommendations selected as a function of the answers or the assessed risks. The responses and report are stored to be used for comparative purposes in future assessments. The technique is useful in assessing risks, although the new and evolving activity may not be well understood or characterized by a data store of experience in similar claims. The technique is useful to build a data store while simultaneously helping to control losses by educating businesses as to their vulnerabilities.

### BACKGROUND OF THE INVENTION

1. Field of the Invention

The invention relates to techniques for determining the risk associated with certain business activities, in conjunction with planning insurance against possible loss, and in particular concerns an automated method and apparatus for identifying and assessing risks arising from Internet and related data processing activities, as well as from other risks for which historical risk assessment methodologies are not available.

2. PRIOR ART

It is known to employ organized risk assessment methods in connection with business insurance, life insurance and other sorts of insurance against personal injury or property damage loss, such as automobile insurance. In these methods, an insurer attempts to assess the risk that a claim will arise from a particular applicant or from a proposed activity, to determine the probability of loss and the likely extent of such loss, and to propose an insurance agreement in which the premium charged for the insurance coverage is related to the risk of loss. This procedure is based on the insurer's historical experience with payments made on claims to insured parties.

It is not possible to use an automated risk assessment process based on historical risk data to assess the potential of loss or the amount of potential loss of a type that has never yet occurred. Although it might be possible to employ such a technique with risks that have occurred infrequently, the insured's experience with very rare or infrequent losses may not be statistically significant and may not be typical of losses of that type.

Some insurance companies make a business of insuring unconventional risks. There are those who profess to have the acumen to assess the probability of loss and the amount of potential loss without the benefit of prior experience. This is obviously a very risky endeavor for the insurer. The premiums charged to customers are likely to reflect the fact that the risk assessment may well be inaccurate due to lack of a reliable history of similar claims.

The objective of insurance is to spread the risk of loss among insured parties who are much more numerous than the number of claimants. The risk of a claim from a given insured party may not be high, but the potential loss could be substantial. The insurance is worthwhile for policyholders, who pay an incremental premium even though a claim is relatively unlikely, because they are protected from the catastrophe of a large loss.

For an insurance company to be profitable, the sum total of premiums charged to policyholders must at least slightly exceed the total paid out in claims. It is not absolutely necessary that insurance premiums be related to the risk in any defined way except that the total premiums must exceed the total claims. Generally, however, insurers attempt to assess the likelihood of a claim and the amount of possible loss, and to charge premiums that are related to the potential losses. By relating the premiums to the probability and likely amount of loss, the insurer can attract policyholders who otherwise would seek less expensive alternatives. Premiums can be lower for policyholders with relatively little risk, if they are pooled separately from policyholders with a higher risk. Companies that are insensitive to differences in risk effectively subsidize high risk policyholders with payments from low risk ones. This is unnecessary if risks can be assessed accurately. By relating the premiums to the probability and likely amount of loss, the insurer can provide a form of encouragement or reinforcement that induces its customers to adopt safer procedures than they might otherwise, or to erect other safeguards.

Insurers rely on their underwriters to determine whether to offer insurance to a particular prospective policyholder, and if so, to determine the amount of premium necessary to cover losses with a reasonable profit to the insurer. Underwriters traditionally rely on statistics and experience to help them determine the probability and likely amount of projected claims. As previously discussed, in the absence of experience, an underwriter may have hunches or instincts or native intelligence to rely upon, but there is no basis for an actuarial assessment. In the absence of experience, an insurance underwriter may be unable to determine and to ask the right questions that might enable the insurer to distinguish among potential policyholders who are more or less likely to suffer a loss, and also to assess the amount of probable loss. Identifying risk-associated attributes and assessing potential losses for new and emerging risks are problems in the field of insurance underwriting.

Automated systems have been proposed to assist in the traditional underwriter function of quantifying the likelihood of loss and the likely amount of loss if a loss should occur. Such systems function similarly to human underwriters and rely on accumulated experience. There are two distinct levels of activity. First, in the same way that an underwriter might develop experience by working in the trade, the automated system stores information that characterizes the attributes and loss experience of past or existing insureds. A variety of attributes may be involved, preferably including at least some critical attributes that correlate dependably with the probability of and amount of loss. Second, in the same way that an experienced underwriter would assess the risk or potential policyholder, the automated system compares the specifics of a potential policyholder's risk factors against the stored information. The automated system predicts a probability of loss and a probable amount of loss, on the assumption that the potential policyholder will have the same probability and amount of loss as previous insureds who are similarly situated.

An example of such an automated system is disclosed in U.S. Pat. No. 5,809,478—Greco et al., which is hereby incorporated for such teachings. The system provides for a series of inquiries to prospective insureds, a comparison of their responses to stored information defining the historical risk pool, the statistical calculation of a probability of loss and an amount of loss, and a determination of a premium level that is related to the average amount that the risk pool suggests the insurer is likely to have to pay out against losses of similarly disposed insureds, with an allowance for a reasonable profit.

The Greco expert system is automated and substantially replaces or at least supplements the experience of an underwriter with the mathematical characterization and measurement of risks. The Greco system is presumably applicable to traditional sorts of insurance and traditionally covered types of losses. There are a variety of types of conventional coverage, such as life insurance, accidental property damage or personal injury coverage, losses due to errors or omissions, certain types of litigation claims and expenses, and the like. Some insurance companies will entertain the possibility of unconventional lines of coverage. The probability and amount of unconventional covered losses should correlate with attributes that underwriters could measure, but usually do not. There may be no historical risk pool against which the prospective insured can be compared, or the historical information may contain less than a statistically significant sampling of losses, or both. In that case there could be a great deal of art, and perhaps luck, associated with assessing risk and setting appropriate premiums.

U.S. Pat. No. 4,975,840—DeTore et al., which is also incorporated, uses a range of categories to define potential policyholders, apparently to better define the risk potential of consumers by widening the range of attributes that might effectively correlate with loss probability and amount. According to this reference, there are medical, non-medical and financial measures taken and stored in connection with insurance against traditional types of personal injury and property damage losses. U.S. Pat. No. 5,970,464—Apte et al., also incorporated, likewise maintains information on numerous possibly arbitrary attributes and by mathematical correlation attempts to define primary or secondary characteristics that are associated with losses. In Apte, an objective is to mine collected data for correlations that can then be made the subject of measure by which potential policyholders are distinguished to better assess potential losses. The system theoretically learns which attributes are important. However, experience is plainly required in order to accomplish such learning.

Data mining applications as described have an associated loss prevention benefit. After an insurer has entered into an insurance agreement, it might be capable of identifying those of its insureds who are most likely to suffer losses by statistical correlation of risk elements to losses as represented by stored data. In that case, the insurer could attempt to educate its insured in how to prevent losses, or to provide the insured with services such as premises inspections, which are known to decrease the incidence of loss. If losses are reduced, everybody wins.

The objective of the automated risk assessment techniques described above is to predict future losses, an inherently risky undertaking. Policyholders' risk profiles change when their business activities and situations change, often generating risk factors that have never or only infrequently occurred before. In those situations, there is no historical information that would permit an analysis sufficient to enable statistically significant correlation of attributes of a party or its situation or activities, with the risk of loss or the amount of loss.

This invention applies risk assessment techniques to an emerging and expanding field of endeavor, namely Internet activity, with the attendant data processing systems and data processing activities, as well as to other emerging risks for which historical risk assessment methodologies are not available, including physical security risks from terrorists activity. The risk of losses from these kinds of activities, and the amount of potential losses, is accelerated by technology. There is not yet sufficient historical data to assess the potential losses with any reasonable accuracy.

Internet activity encompasses a variety of specific endeavors. However, the endeavors have in common certain risks related to the nature of the network and the uses to which it is put. Transactions including the transmission of sensitive or valuable data are routinely handled over a network to which a very large number of users have access. Even routine matters may be subject to huge variations in the level of demand. There are many benefits to the improvements in communication that result from widening use of the internet, and there are also risks that may be unexpected yet capable of causing severe damage.

One category of risk is related to data security and limitation of data access. A number of assessment tools are available. (See, e.g., http://www.securityspace.com/sszone/data/Security_Zone/Vulnerability_Assessment/.) According to U.S. Pat. No. 6,185,689—Todd, Sr. et al., and the publicly available SATAN security assessment program (SATAN is an acronym for “Security Administrator's Tool for Analyzing Networks”), such tools can be used to assess the vulnerability of a network to certain forms of hacker attack. This system effectively collects facts about a data network, and correlates these facts with security warnings that have been published by international authorities. These kind of systems are useful for identifying vulnerabilities and pointing them out to the customer, but are not configured for or sufficient from an insurer's standpoint to assess the possibility of loss and the amount of potential loss, resulting from a hacker's successful exploitation of an identified vulnerability. They are also directed to technically savvy data administrators as opposed to other vulnerable parties.

According to an aspect of the present invention, the likelihood and likely extent of losses related to Internet activity, data processing systems and data processing activities can be assessed from a detailed review of a business entity's legal hardware systems and software vulnerabilities using a prompted response technique.

A thorough legal assessment of Internet activity can include delving for information respecting the potential for claims at least involving intellectual property issues (trademark, copyright and patent infringement), breach of privacy, theft of trade secret or other proprietary information, unfair competition, contractual and state, federal and foreign regulatory issues. An assessment of any entity's information technology should also include a review of the data capacity of the systems for storage or throughput, contractual arrangements with employees, suppliers and customers, reliability factors respecting the human staff as well as the systems, the sensitivity of the information that is being handled changes in the company's operations over time, and numerous other risk enhancing or risk inhibiting aspects of an Internet activity.

It would be advantageous to have in place a risk assessment process that is sensitive to legal and data related risks, that benefits from automation, and that generally improves the accuracy of risk assessments while reducing loss potential. Over time, such an automated process will yield a historical and retrievable data base of information that will enhance an underwriter's risk assessment abilities.

This invention is intended to provide a risk assessment and evaluation tool that assesses risks using a set of rules. These rules are meant to be employed at least until the point that historical information becomes more reliable for risk assessment. It may be that this point is never reached because of constantly evolving technology and changing business methodologies, in which case, the roles will remain in place. The rules are also useful as a risk management tool.

Knowledge of the elements of assessed risks provide an incentive for an insured party to modify its behavior with respect to such elements, if for no other reason than the fact that risk assessment affects the premiums that insurance companies change.

Effective risk management often results in the reduction of premiums as well as in the decrease in the frequency and severity of losses, in short, a win-win situation for insurers and insureds. These benefits accrue even if in the long run it proves that the rules that associated a particular activity with a loss were not as accurate as might have been possible from statistically significant actuarial data.

### SUMMARY OF THE INVENTION

It is an object of the invention to improve the extent to which the insurance industry in general, and underwriters in particular, are aware of the need for insurance products and are capable of reasonably writing coverage for both familiar and emerging risks associated with automated business techniques, especially doing business on the Internet. By a series of prompted responses, a potential insurance customer's operation is assessed as to risks and potential losses, including for new and emerging risks heretofore unquantified, such as risks from attacks mounted by anyone from terrorists to disgruntled competitors and the like.

Important categories of insurable risks arise from exposure to legal risks and from the use of information technology. The barriers to profitable entry into this field of insurance include the lack of knowledge and experience on the part of many insurance underwriters, sufficient to enable them to ask the right questions, to assess accurately the risks revealed by the answers to appropriate questions, to arrive at a premium fairly related to the probability and probable amount of loss, to process applications for insurance against Internet-related and other emerging risk activities in a commercially reasonable time, and to provide for monitoring and updating the risk profile of insureds. Another object of the invention is to eliminate such entry barriers.

The invention comprises an organized and comprehensive, system and method for assessing technical, legal and management intertwined risks. By providing prompting using a series of targeted questions presented by an automated assessment routine, the invention is flexible and adaptable to yet-undiscovered risks. For example, the prompting can be updated when necessary to accommodate new court decisions, changes or new interpretation of regulations or statutes, newly deployed technology and the like. The assessment technique is efficient, providing relatively comprehensive assessments in a short turnaround time. The assessment is scalable as needed, for example being expandable to more or less extensive levels of detail for particular risk fields in which there is more or less at stake or more or less information needed to distinguish risk from safety.

These and other objects and aspects of the invention are met according to certain particular examples that are disclosed in detail. However it should be understood that the invention is capable of certain variations in accordance with its scope as provided in the appended claims.

### BRIEF DESCRIPTION OF THE DRAWINGS

FIG. 1, appended hereto, is a schematic flow chart illustrating the attributes of the invention according to a preferred embodiment.

### DETAILED DESCRIPTION OF PREFERRED EMBODIMENTS

In a general sense, the invention concerns composing a series of targeted questions, having responses that enable a qualitative and quantitative assessment of certain risks, presenting the questions to a potential insurance customer or another interested party such as a potential insurance underwriter, projecting a level of risk and a level of potential loss based on the responses, and presenting the results.

An exemplary set of questions is attached as an Appendix and made a part of this disclosure. It should be appreciated that it is possible according to the invention as disclosed and claimed, to employ other specifice questions that delve more or less deeply or are directed to similar or different areas of investigation. The questions shown in the Appendix should be considered nonlimiting examples that illustrate a preferred application of the invention.

To the extent judgment is required in the application on construction of the various elements of the invention, an attorney with ordinary skill in the legal profession and/or an information technology professional with ordinary skill in his profession, can practice the invention according to the description that follows.

First, a selection is made regarding the categories of insurable risks to be addressed. The invention is particularly applicable to emerging risks, particularly risks related to data processing and network communications, and thus encompasses many modern business activities. In the illustrated example the categories are initially divided into major categories of potential risks, such as legal and non-legal. Potential legal risks are frequently related to codified precepts that can be reflected in prompted questions intended to discern critical facts. Non-legal risks are often of a technological nature or are capable of assessment as a function of technological details of a business structure and operation.

These categories are further divided into sub-categories as set out in detail below. The input for the selection is composed of a number of sources including on-line and hard copy reports of decided cases, new and existing statutes, reports of technological risks including hacking and viruses, and new technology. The legal and technological selection process is part judgmental and part automatic. In the former category, for instance, are the decisions as to which recent court opinions can affect a business entity's Internet risk profile. In the latter category, as another example, are statutory enactments relative to Internet activities, the provisions of which are automatically made the subject of the appropriate legal risk category.

A next step is to draft a series of questions to prompt for the critical facts. This process also is partly judgmental and partly automatic. For instance, in deciding to include a question reflecting a recent court decision, the judgment of a lawyer, and perhaps of a technological expert, may be required. This exercise of judgment is no more than can be exercised readily by an attorney or technological expert of ordinary skill in his or her profession, given the fact that a legal precept has been stated or a technological aspect has been identified that is vulnerable to exploitation or may be damaged from inadvertence or mistake.

There are some matters that require little, if any, judgment to compose an appropriate question. For instance, if an identified risk is a claim under an Internet-related statute, there is little doubt that a competent attorney would include a question or questions concerning compliance with that statute so as to assess the potential for a valid claim related to it. Similarly, there is no option but for a competent systems security specialist to include certain questions related to well identified business vulnerabilities such as attacks that are normally countered effectively by providing appropriate firewalls. There are also a variety of questions that are likewise intended to glean information that tends to distinguish parties vulnerable to risks from parties that are not vulnerable and to assess both the extent of potential loss and the probability of a claim or a successful claim.

Preferably, all the questions are drafted to yield one of a limited set of potential answers, each of which is handled by the risk assessment procedure. Thus, preferably all questions will prompt for an answer of one of “yes,” “no,” “don't know,” or “not applicable,” or will yield a numeric answer that is required to be within a given valid range. These answers provide answers or, in some cases, a numeric answer or range. The questions and their answers should be relatively objective, but it is also possible to employ the judgment of the answerer to rate his or her belief over a scale as a means to statistically distinguish one group of answerers from another (for example to assess the user's confidence in their answers).

The precise questions can evolve and be edited, improved for targeting, supplemented, etc. Over time, the questions can become an increasingly valuable asset to the insurance industry and to its policyholders. Prior to this invention, insurance underwriters, by their own admission, did not know how to ask the right questions upon which to base a reasonably accurate risk assessment. Lacking a reasonable risk assessment, they were unable to fairly price the coverage needed and desired by a policyholder.

As mentioned above, the questions are drafted to elicit a limited set of valid answers, thereby facilitating a procedure such as a programmed procedure to deal with every possible scenario for answers to a given question. These procedures also can employ the answers to two or more questions simultaneously in an if/then/else and/or a numeric scaling fashion to assess the probability of a loss and the possible amount of damage (both generally affecting the “risk” as discussed herein).

Accordingly, prospective insureds reply to question prompts with answers yielding an objective response or at least a response that is useful as an objective input or variable to a process that uses the answer to assess risk. Preferably, prospective insureds do not have the option to answer the questions with “maybe,” or “in some cases,” or “sometimes” or similar subjective answers. Alternatively, such answers can be permitted answers that are dealt with by the process in a way that reasonably assesses risk. For example, if an insured in a position of authority expresses ignorance about some critical area, that can be factored into the risk assessment as a parameter that correlates to a greater risk than a similarly situated insured who answers in a manner indicating a working knowledge of that area.

The insureds can be required to answer all questions definitively. For instance, either a business complies fully with the requirements of a certain statute, or it does not. If an intermediate or indefinite answer is permitted, it can be interpreted as an unfavorable response. In any event, the process is arranged to deal with the answers in a manner that can identify risks. This part of the process is completely automatic and elicits the kinds of representations that an insurance underwriter needs to understand the extent of risk and to price the coverage. However it is done in risk areas where the underwriter who uses the risk assessment may be less familiar than he or she is used to receiving in other insurance contexts.

The process then drafts, selects or otherwise offers responses as a function of the answers to the prompts submitted by or on behalf of the user that is being assessed. This process should be non-judgmental and automatic for best results. An answer reflecting compliance with a statute, for example, can yield automatically a favorable response along the lines of “keep doing what you are doing” or “no risk identified,” etc. A negative can yield a response detailing the consequences of non-compliance or simply noting that a risk has been identified. Where there is a numeric input, the risk can also be quantified.

Warning messages as to identified risks can explain at various levels of detail, or the system can allow the user to select or change a level of detail, e.g., “drilling” down into the specifics behind a warning or a numeric risk assessment that is reported.

In the case of legal compliance warnings, the text can be generally taken directly from the associated statute or rule. A minimum warning could simply state that a risk has been identified and is subject to amelioration (i.e., by complying with the statute or rule). A more sophisticated warning could relate that warning to other related risks. Drilling down in the information can produce the text of the rule or statute, reported cases applying the rules, etc. Alternatively the warnings can be more limited, or perhaps include only standardized warnings about the possibility of lawsuits and the fact that lawsuits carry associated expenses.

In one embodiment, the invention is applied simply for the benefit of determining premium levels. The series of questions simply place users into one of a plurality of grouped risk pools for which premiums are set accordingly. In a more user friendly embodiment, the invention instructs the users and assists in reducing the danger of loss. A more sophisticated embodiment can provide extensive information on demand, or alternative messages intending for the user of the potential insurance customer, for the use of the underwriter that approves coverage and/or sets premium rates, and additional messages that are intended for use by development personnel who monitor the answers of insured and their loss experience, and attempt to add or revise questions and to draft more useful or more extensive answers where possible. Any judgment called for in drafting responses can be exercised by an individual possessed of ordinary skill in his or her profession.

In a preferred embodiment, the risk assessment of the individual categories and sub-categories is limited certain risk categories, e.g., “low”, “medium” or “high”. A lawyer or information technology specialist of ordinary skill in his or her respective professions could assign the risk assessment associated with a given answer to a question. For instance, a “no” response to a particular statute compliance question, as well as a “don't know” response, might always yield an assessment of “high” risk. A “yes” response might invariably will yield a “low” risk assessment, or might default to “medium” and only be revised to “low” (or perhaps to “high”) when some other factor was also present. In some instances, qualifiers may be needed, such as when the set of yes and no and numeric answers appear to have some unusual pattern. In that case, lawyers or information technology specialists of ordinary skill can review the results and produce further information either to assist in underwriting functions or to provide ongoing improvement of the automated risk assessment.

The scoring of the risk assessment, once a “high”, “medium” or “low” risk assessment is assigned, can be completely automated with no judgment required. A given “yes” answer might yield a certain, pre-programmed risk score, as would a give set of “no” and/or “don't know” answers. By asking a number of answers over a range of subject areas, the user's status in a risk range can be identified.

Preferably, an informational report is generated that contains information identifying the party answering for the potential insured, the date of the inquiry and other factors that may be useful for later reference. The report to the user can include the questions and responses or simply the risk assessment information developed from the responses. In a more sophisticated arrangement, the report can include individual and cumulative risk assessment values, comments, recommendations, and an executive summary. These aspects are all readily automated by preprogramming the system to provide selected outputs as a function of given inputs as described above.

The automatic nature of the system as described has the benefit of a very short turnaround time for completing an inquiry and for generating a useful report. This is another element that makes the invention unique and useful to the insurance industry and to its policyholders. Instead of requiring the policyholder to undergo complete “manual” legal and technological audits of its business, which might be conducted by different people at different times and in with somewhat different results, the invention permits a quick, detailed and repeatably standardized risk assessment. This assessment is preferably made in sufficient detail and with sufficient information at hand to make a meaningful decision about coverage and/or premium rate, with a turnaround from minutes to days, as opposed to weeks or months after commencement of the initial contact or input.

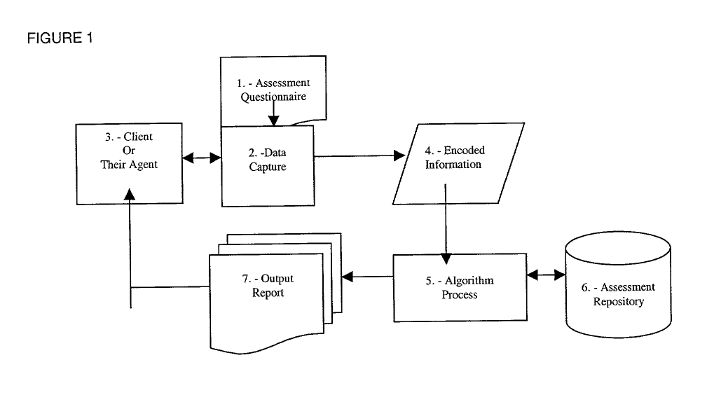

The elements of the invention and their interrelationships are identified in FIG. 1. An Assessment Questionnaire (1) is a collection of questions whose responses will be used by the algorithm process to create the output report. The questions are grouped into common areas. In a process of Data Capture (2), an applicant is subjected to an inquiry in which representations are made in response to a series of automated prompts. The prompts can be identical for all subjects, or the prompts can be produced by a branching procedure whereby the answers to earlier questions determine in which questions will be presented later. The process of data capture may use various methods, including but not limited to paper, personal computers (questionnaire and responses on floppy disks), and interactive access such as access to an Internet site programmed in Java or another language to present the questions and collect the responses. In any event, the client completes the Assessment Questionnaire.

The result is a more or less extensive set of Encoded Information (3) that represents the completed responses to the questionnaire. These responses can be encoded in any acceptable format for use as an input to an Algorithm Process (4), wherein the data obtained as responses, or perhaps a preprocessed set of data that results after applying further processing steps such as selection of points in numeric ranges as a function of specific responses, weighting, interaction of related answers, etc.

Generally the process (4) takes the user response data through several steps including utilizing the database to assign weights to responses based on the risk potential, which may be indicative of increasing or decreasing risk levels, reviewing for completeness (blanks and ‘don't knows’) and possibly profiling or otherwise determining whether the data has some overall pattern, calculating normalized scores for each questionnaire section or each individual question or area of risk, preferably creating graphs or similar informational aids for representing the responses, retrieving the appropriate responses such as text warnings for one or more of the questions, and creating the body of the report to be reported on a webpage or transmitted by email or printed, etc.

The collected data is useful to develop historical data and to improve the effectiveness of the risk assessment, as well as to set premiums and to make coverage decisions. The user's answers or a version of data representing the user's situation is stored in an Assessment Repository (5). This may contain any or all of the raw answers, the scoring algorithm data, predrafted responses for each question, and summaries by section for various scoring levels, and overall summary comments.

The Output Report (6) shown in FIG. 1 is the assessment report which includes the summaries, graphical summaries of the responses, detailed responses to each question answered. This data is reported to the Client (7) for further appropriate action.

According to preferred arrangements as described, the invention relies on segmentation of the risk areas. For example, potential risk areas can be categorized and treated by distinct legal, technological and management areas. A given user response, however, may have an impact in more than one of the risk areas.

Legal risk is segmented, for example, into a) the general practice area of Intellectual Property, and into sub areas of patent, trademark and copyright; b) confidentiality, trade secrets and privacy; c) e-mail; d) contractual obligations and reliance on contractual obligations of others; e) environmental, and so forth. The non-legal, technological/management areas are segmented into a) data protection; b) network management; c) network access; d) external networks and points of access; e) data management and access; f) virus protection; and g) disaster recovery. There can be overlap in the categories, but organization by categories facilitates risk assessment and reporting.

This segmentation assists the assessment and also permits an attorney or other person with a specialty, such as copyright law as a legal example, or information technology management as a technical one, to draft pertinent targeted questions, to interpret responses and generally to set up the risk assessment to provide repeatable risk assessment figures for all subsequent users who respond with a similar set of responses to predetermined inquiries. Once the system is set up, it can operate with little attention or judgment. However, the system preferably is updated and improved with experience. The system can be arranged to flag peculiar response profiles for specific attention by an operator, to collect and report on statistical information about respondents, to cross correlate reported losses with responses, and otherwise to assist in monitoring and revising the system to improve its results.

The specific forms of input and output, such as the form of questions presented to the subjects and the form in which output data is returned, preferably is similar to the forms of questions that a professional, legal or nonlegal, would likely ask any person or company that had come to him or her for professional advice, for instance in the area of copyright law, or in the area of data protection. The format of each question lends itself only to “yes”, “no”, “don't know” or “not applicable.” Some of the questions can trigger other questions in a branching decision tree. This can be programmed into the manner in which questions are presented automatically, or can be partly a user response function. For example, a question might ask, “If you answered ‘yes’ to the preceding question, state . . . [etc.].” Most of the questions are standalone questions with discrete or numeric responses.

Similarly, the predetermined responses to users who submit a given set of answers is also presented with many of the same forms that a professional might include in a written report containing advise, such as particular descriptions, disclaimers and the like. Thus the result is in some ways similar to an automated report from that professional. Preferably, each response is relatively short, for example from a sentence or two to a paragraph or two. As discussed above, the response can be made variable in length at the user's option.

At least some of the automated responses or warnings can be accompanied by appropriate recommendations. As in structuring the questions and responses, the recommendations are of a kind that a legal or non-legal professional of ordinary skill might make in light of a given response to a question.

By way of example in the copyright area, it is known to professionals but not to many underwriters that the ownership of a copyright can be affected by employment relationships and by whether or not conveyances are in writing. More specifically, the copyright in an employee's work is that of a work for hire and is owned by the employer. However the copyright in an independent contractor's work remains that of the independent contractor, as opposed to the party that contracted with him, unless there is a written conveyance. Thus, according to the invention, a “no” response to the question:

Do you have written contracts with any independent contractors who are preparing works for your use, stating whether you or they are to own the copyright in their works?

. . . would yield a risk assessment of “high” because not having such contracts can lead to uncertainty, disputes and after-the-fact claims of ownership. An attorney of ordinary skill practicing in the area of copyright law would know to ask this question in a way that distinguishes employees from independent contractors, how to identify from responses of the answering party whether they understood the question, how to frame an appropriate response or warning, and what level of risk to assign to the response. Thus the assessment of risk in this arcane area can be readily and usefully automated. The appropriate warning likewise explains the problem and how and why it is correctable.

The correlation between responses and risk assessments is generalized. Preferably, at least the risk levels are categorized based on responses as being “low”, “medium” or “high.” In the event that an unrecognized or intermediate response is permitted, the risk can be stated as “unknown” and any premium or coverage decision made on the assumption that the risk is high. To a large extent, the invention provides the risk assessment benefits of unfamiliar legal and technological situations, particularly as associated with modern network methods of doing business, without requiring the exercise of judgment in individual cases.

A formulaic correlation of risks to answers is accomplished by assigning a score to each response for each question or perhaps to certain associated sets. These are assigned so that a high score means additional risk. Many sections have initial questions where a ‘no’ or a ‘don't know’ response means that the risk for that area is high and is so assigned. In that case, a ‘no’ or ‘don't know’ response may be programmed such that the remaining questions for the section become moot and can be bypassed. On the other hand, if the response to initial questions are positive as series of refining questions can be prompted to the subject and the responses scored and totaled as a raw score.

The raw score for a given user can be normalized where appropriate in order to present the potential risk in each area in a similar fashion. Thus, although a user's responses may be numerically distinct on a category-by-category basis, normalization can be used to remove category skew, for example such that category-by-category scores are produced wherein each category has a normalized maximum and the scores for the respective categories are normalized to fall between zero and 100%, or some other figure representing a maximum potential risk assessment figure. In a simple example having a predetermined maximum score, the normalized score in a category is developed by dividing the summary score for the client specific responses by the maximum potential score, yielding a category score between zero and 100%.

The relationship between the questions, responses and recommendations, preferably forms a framework for risk assessment and risk management in legal, technological and managerial areas and in the interrelationship of all three areas. By way of an example, a company dealing in personal information that does not have adequate firewalls could well face claims of breach of privacy. A company with adequate firewalls that does not manage the effectiveness of the firewalls or provide adequate funding for this managerial function, could face similar claims. If the company has inadequate employment agreements with its technicians and managers, its risk, and the corresponding reasonable premium to be assessed, is high. Thus the numerical assessments in particular categories, or the total assessment, can be a function of responses in several categories.

There is a specific relationship between a “don't know” and a “high” risk assessment. For certain critical areas, a lack of knowledge should always correlate with high risk. This can be automatic in such areas. For example, a “don't know” response may identify that a manager is unqualified, or that management is relatively lax, which justifies assessment of high risk. In any instance where a “yes” or “no” response would respectively bring an assessment of high risk versus low risk, a “don't know response” means that there is at least a 50-50 chance that the risk assessment should be high, so the answer can be programmed to produce an intermediate risk assessment. Finally, some yes-or-no answers are so important as to affect whether the underwriter will be willing to write coverage at all. In that case, a “don't know” response can be arranged to block the risk assessment because the assessment would be undependable at best and unacceptable for the underwriter's purposes.

The relationship between the cumulative responses in a given area and the graphical presentation of the risk can be direct or normalized. The data can be presented graphically in alternative categories generated from overlapping data sets. The graphical presentation can properly be called a histogram in that in that the areas and positions of the blocks on the graphs are proportional to the values assigned which, in turn, represent a number of variables.

Thus in an exemplary process, the Assessment Questionnaire is presented, namely a collection of targeted questions. The Questionnaire is used to prompt an insurance applicant to make certain representations. The responses or representations are used by an algorithm process that comprises accumulating positive and negative data points that are weighted and added, and optionally normalized, to create the output report in which the risk attributes of the subject are set forth.

The questions are grouped into common areas of potential risk such that a competent attorney practicing in a given area of risk (e.g., patent, trademark or copyright law), or a competent technological professional specializing in a given technology (e.g., systems security) can formulate the question, draft responses that seek quantifiable answers or one of a limited set of possible answers (e.g., “yes”, “no” or “don't know”). The results can produce a single risk score used for calculation of a premium, and preferably produces categorized scores and uses the answers to select from a database and to display curative recommendations. The questions preferably are diagnostic, and the recommendations preferably are informative. In addition to operating the system for particular assessments, the system is a data collection tool whereby a record of responses is obtained and stored for a preferably large number of diverse subjects, permitting data mining, data correlation studies and similar actuarial functions, in addition to direct assessment of risks for facilitating underwriters' coverage and premium pricing decisions.

In a Data Capture phase the system collects the responses of the insurance applicant to the Assessment Questionnaire. The data can be captured in any medium, including paper forms, but an electronic format may be preferable to reduce reliance on further encoding if the preferred automated process method is used to turn the answers into an output. That is, if the input is obtained on paper, such as using check-off boxes or the like, it preferably is transferred to an electronic format for processing. The electronic data is the responses to the questions, including the administrative ones identifying the client.

The Client or subject is the entity that completes or on whose behalf the questionnaire is completed. Preferably, the specific person is an authorized agent, employee or representative of the potential insured, such that the answers can be treated as representations by the insured. The responses that are collected are a form of Encoded Information that is or is transferred to and electronic data format of a standard sort.

According to an inventive aspect, a programmed process or algorithm carries the answers or raw data input through several steps. At a minimum, a datum identifying the response data, when entered, is coupled with an identifier that signifies which question was answered. This provides an associated record of the response that was selected and the prompting, from which a risk level is assigned or inferred, either alone or in conjunction with other questions and responses. Assuming a question-by-question embodiment, a formulaic correlation is accomplished by first assigning a score to each response for each question. For example, “yes” could represent one, and “no” or “don't know” could represent minus one. These scores can also be weighted (i.e., multiplied by stored weighting factors), so that questions directed to more dire possible losses are assigned higher weights. The question scores are accumulated and provide a numeric risk assessment of a point between maximum and minimum risk assessment limits. This can be accomplished by risk categories of by a summary total.

In this example, a high score correlates with a high risk. Certain categories or question segments or sections can have initial questions where a ‘no’ or a ‘don't know’ response means that the risk for that area is high and is so assigned. Any ‘no’ or ‘don't know’ responses may mean that the remaining questions for the section are bypassed or may be stoppers that prevent completion until the question is answered, or may be flagged as needing answers, or may simply be processed as if an unfavorable response (indicating high risk) had been given.

The questioning can follow a branching path wherein responses to initial questions determine the nature of followup questions seeking to refine the collected information. If the response to these initial questions is yes, the remaining questions have their responses scored and totaled as a raw score.

The raw score can be normalized in order to present the potential risk in each risk area in a similar fashion. Alternatively it is possible to skew the report to represent some risks as more important than others as similarly calculated. By normalization, the maximum score for each section is accumulated and equated to 100%, representing a maximum potential risk. The user's actual score is then developed by dividing the summary score for the client specific responses by this maximum potential. This means each section will have a range of risk scores between 0% and 100%, with 100% being the highest. Each response has in the repository a numeric base level risk value, suitable commentary and recommendations to address the risks in the area. There are processing rules for those questions that trigger other questions. The algorithm also reviews the responses for completeness, calculates the normalized scores for each questionnaire section, creates the graphs, retrieves the appropriate responses to each question, and creates the body of the report.

An Assessment Repository stores the scoring algorithm data, the responses given for each question, and summaries by section for various scoring levels, and overall summary comments. An Output Report is generated, preferably containing summaries, a graphical presentation of the summaries of the responses, optionally the detailed responses that were given to each question answered, and recommendations that are selected from a database to advise the user of background information that explains how or why the user's specific responses appeared to indicate risks (or perhaps to state that the user's answers suggested that certain risks were reasonably in hand).

The invention has been discussed with respect to certain preferred arrangements and embodiments, but as discussed is capable of embodiment in more or less extensive ways. The invention should be construed to include the specific arrangements and alternatives discussed above, and to be limited by the appended claims as opposed to the discussion of specific examples of how the invention can be practically arranged.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for assessing risks, comprising:
creating a questionnaire containing a series of questions form prompting a user to supply information segmented according to risk areas;
providing a data store for recording data identifying user responses to the questions;
programming a series of scoring rules containing an algorithm whereby the user responses are interpreted as indicating a predetermined level of risk;
presenting the questionnaire to a user and collecting the user responses in the data store;
processing the user responses through the scoring rules and the algorithm to generate a report identifying risk levels according to the risk areas.

2. The method of claim 1, further comprising storing a series of recommendations associated with the risk areas, selecting among the recommendations as a function of at least one of the user responses and the risk levels identified by said processing step, and presenting selected ones of the recommendations in the report.

3. The method of claim 1, further comprising creating a database and storing the questions and the user responses for a plurality of users for comparison in risk assessments of future users.

4. The method of claim 1, at least one of segmenting of the risk areas, creating the questionnaire and composing the algorithm comprises reliance on available data and judgment of professionals skilled in the risk areas.

5. The method of claim 1, wherein the risks comprise at least one of risk of a claim of loss due to computational deficiency, denial of service, security breach, violation of legal regulations, tort, contractual breach, insufficient capacity to meet contractual requirements, breach of commitment of confidentiality, violation of intellectual property rights, failure to adhere to multi-jurisdictional differences in regulation.

6. The method of claim 1, wherein the risks are selected from the group consisting of risk of a claim of loss due to computational deficiency, denial of service, security breach, violation of legal regulations, tort, contractual breach, insufficient capacity to meet contractual requirements, breach of commitment of confidentiality, violation of intellectual property rights, failure to adhere to multi-jurisdictional differences in regulation.

7. The method of claim 1, wherein the risks consist of risk of a claim of loss due to computational deficiency, denial of service, security breach, violation of legal regulations, tort, contractual breach, insufficient capacity to meet contractual requirements, breach of commitment of confidentiality, violation of intellectual property rights, failure to adhere to multi-jurisdictional differences in regulation.

8. The method of claim 1, wherein said questionnaire requires selection among a limited set of possible answers and the algorithm quantifies risk based on each possible answer.

9. The method of clam 8, wherein the questionnaire requires selection among yes/no and numeric answers.

10. The method of claim 8, wherein the questionnaire permits at least one of a missing answer and an answer indicating a lack of information, and wherein the algorithm assesses the risk levels as a function of said one of a missing answer and said lack of information.
